(19) United States
(12) Patent Application Publication
(10) Pub. No.: US 2023/0391050 A1
(43) Pub. Date: Dec. 7, 2023

(54) HYBRID KNITTED FABRICS AND LAYERED COMPOSITE MATERIALS FOR NON-SCORE PASSENGER AIRBAG APPLICATIONS

(71) Applicant: INTEVA PRODUCTS, LLC, Troy, MI (US)

(72) Inventors: Kevin M. Lyons, Royal Oak, MI (US); Xinhua He, Bloomfield Hills, MI (US); Kenneth Gassman, Lake Orion, MI (US)

(21) Appl. No.: 18/206,917

(22) Filed: Jun. 7, 2023

Related U.S. Application Data
(60) Provisional application No. 63/349,843, filed on Jun. 7, 2022.

(51) Int. Cl. B32B 5/24; D02G 3/02; D02G 3/44; D04B 21/20; D04B 1/16; B32B 5/02; D04B 1/22; B32B 5/18; B32B 27/12; B60R 21/231; B60R 21/235

(52) U.S. Cl. CPC B32B 5/245; D02G 3/02; D02G 3/446; D04B 21/20; D04B 1/16; B32B 5/026; D04B 1/22; B32B 5/18; B32B 27/12; B60R 21/231; B60R 21/235; D10B 2321/022; D10B 2331/04; D10B 2505/124; D10B 2401/063; B32B 2262/0253; B32B 2262/0276; B32B 2605/003; B32B 2274/00; B32B 2266/0292; B60R 2021/23509; B60R 2021/23523; B60R 2021/23552; B60R 2021/2358

(57) ABSTRACT

The present disclosure provides advantageous hybrid knitted fabrics and composite materials including hybrid knitted fabrics, and improved systems/methods for utilizing and/or fabricating the hybrid knitted fabrics and composite materials. More particularly, the present disclosure provides layered composite materials including hybrid knitted fabrics, the layered composite materials advantageously configured for non-score deployable passenger airbag applications.

### CROSS-REFERENCE TO RELATED APPLICATION

The present application claims priority benefit to a provisional application which was filed on Jun. 7, 2022, and assigned Ser. No. 63/349,843. The entire contents of the foregoing provisional application is incorporated herein by reference.

### FIELD OF THE DISCLOSURE

The present disclosure relates to hybrid knitted fabrics and composite materials including hybrid knitted fabrics and, more particularly, to layered composite materials including hybrid knitted fabrics, the layered composite materials configured for non-score deployable passenger airbag applications.

### BACKGROUND OF THE DISCLOSURE

In general, knitted textiles are used in a range of applications and can be combined with other materials to form layered composite materials. For example, artificial leather can be a composite material that includes a knitted textile bonded to a polymeric layer. When these layered composite materials are used in some applications it can be necessary to score (weaken) the backside of areas of the layered composite material in order for the layered composite material to be installed and/or utilized. Scoring can result in some problems such as translation of the scoring to the front side (visible side) of the layered composite material with a loss of aesthetic appeal. Another problem with relying on scoring is that due to the viscoelastic nature of polymers, it is theorized that, over time and due to elevated temperatures, the scoring pattern can “heal” to a certain extent and change the expected performance of the scoring and/or deployment. With specific reference to “healing” it is noted that knife scoring can be the worst. Laser scoring burns away (removes) material from the polymer layer.

As described and disclosed in U.S. Pat. No. 10,703,318 (the entire contents of which is hereby incorporated by reference in its entirety), a covering may include a score line, e.g., a weakened area that will be opened by an airbag inflating.

An interest exists for improved knitted fabrics and composite materials including knitted fabrics, and related methods of fabrication and use.

These and other inefficiencies and opportunities for improvement are addressed and/or overcome by the fabrics, composites and methods of the present disclosure.

### BRIEF SUMMARY OF THE DISCLOSURE

The present disclosure provides advantageous hybrid knitted fabrics and composite materials including hybrid knitted fabrics, and improved systems/methods for utilizing and/or fabricating the hybrid knitted fabrics and composite materials. More particularly, the present disclosure provides layered composite materials including hybrid knitted fabrics, the layered composite materials advantageously configured for non-score deployable passenger airbag applications.

The present disclosure provides for a hybrid knitted fabric including a first yarn having a single end break of 350 grams or lower and a linear density of 30 denier or higher; a second yarn having a single end break of 450 grams or lower and a linear density of 20 denier or higher; and wherein the first yarn is present in an amount that is greater than or equal to an amount of the second yarn.

In addition to one or more of the features described, or as an alternative to any of the foregoing embodiments, the first and second yarns are solid yarns; the first yarn has a single end break of from 30 to 300 grams, and a linear density of from 75 to 250 denier; and the second yarn has a single end break of from 30 to 300 grams, and a linear density of from 40 to 200 denier.

In addition to one or more of the features described, or as an alternative to any of the foregoing embodiments, the first and second yarns are solid yarns; the first yarn has a single end break of from 200 to 250 grams, and a linear density of from 150 to 210 denier; and the second yarn has a single end break of from 175 to 225 grams, and a linear density of from 60 to 100 denier.

In addition to one or more of the features described, or as an alternative to any of the foregoing embodiments, the first and second yarns have hollow cross-sections; the first yarn has a single end break of from 50 to 200 grams, and a linear density of from 35 to 140 denier; and the second yarn has a single end break of from 40 to 175 grams, and a linear density of from to 65 denier.

In addition to one or more of the features described, or as an alternative to any of the foregoing embodiments, the first yarn comprises polyester; and the second yarn comprises polypropylene.

In addition to one or more of the features described, or as an alternative to any of the foregoing embodiments, the first yarn is present in an amount that is greater than an amount of the second yarn.

In addition to one or more of the features described, or as an alternative to any of the foregoing embodiments, a hybrid knitted fabric further comprising a third yarn; and the third yarn comprises polyester.

In addition to one or more of the features described, or as an alternative to any of the foregoing embodiments, the hybrid knitted fabric extends from a first end to a second end; a first region proximal to the first end comprises the first yarn; and a second region proximal to the second end comprises the second yarn.

In addition to one or more of the features described, or as an alternative to any of the foregoing embodiments, the single end break of the first yarn is greater than the single end break of the second yarn.

The present disclosure also provides for a composite material including a hybrid knitted fabric and a first layer on the hybrid knitted fabric; the hybrid knitted fabric has a first yarn having a single end break of 350 grams or lower and a linear density of 30 denier or higher, and a second yarn having a single end break of 450 grams or lower and a linear density of 20 denier or higher; and the first yarn is present in an amount that is greater than or equal to an amount of the second yarn.

In addition to one or more of the features described, or as an alternative to any of the foregoing embodiments, the hybrid knitted fabric and the first layer are configured and dimensioned to be positioned relative to a vehicle airbag and to allow the vehicle airbag to break through the hybrid knitted fabric and the first layer without pre-scoring or pre-weakening the hybrid knitted fabric and the first layer.

In addition to one or more of the features described, or as an alternative to any of the foregoing embodiments, the first layer comprises a solid thermoplastic elastomer.

In addition to one or more of the features described, or as an alternative to any of the foregoing embodiments, a composite material further comprising a second layer on the first layer; wherein the first layer comprises a foam layer, and the second layer comprises a solid thermoplastic elastomer.

In addition to one or more of the features described, or as an alternative to any of the foregoing embodiments, the first layer comprises a foamed thermoplastic elastomer.

In addition to one or more of the features described, or as an alternative to any of the foregoing embodiments, the second yarn is chemically bonded to the first layer.

In addition to one or more of the features described, or as an alternative to any of the foregoing embodiments, the hybrid knitted fabric comprises a mechanical or chemical finished region.

The present disclosure also provides for an automotive component including a substrate having an inner surface and an outer surface; and a composite material disposed relative to the outer surface of the substrate; the composite material comprises a hybrid knitted fabric and a first layer on the hybrid knitted fabric; and the hybrid knitted fabric has a first yarn having a single end break of 350 grams or lower and a linear density of 30 denier or higher, and a second yarn having a single end break of 450 grams or lower and a linear density of 20 denier or higher; and the first yarn is present in an amount that is greater than or equal to an amount of the second yarn.

In addition to one or more of the features described, or as an alternative to any of the foregoing embodiments, the substrate is positioned relative to a vehicle airbag; and a spacer fabric layer is positioned on the outer surface of the substrate.

In addition to one or more of the features described, or as an alternative to any of the foregoing embodiments, the hybrid knitted fabric and the first layer are configured and dimensioned to be positioned relative to a vehicle airbag and to allow the vehicle airbag to break through the hybrid knitted fabric and the first layer without pre-scoring or pre-weakening the hybrid knitted fabric and the first layer.

In addition to one or more of the features described, or as an alternative to any of the foregoing embodiments, the first yarn comprises polyester; and the second yarn comprises polypropylene.

The above described and other features are exemplified by the following figures and detailed description.

Any combination or permutation of embodiments is envisioned. Additional advantageous features, functions and applications of the disclosed fabrics, composites and methods of the present disclosure will be apparent from the description which follows, particularly when read in conjunction with the appended figures. All references listed in this disclosure are hereby incorporated by reference in their entireties.

### BRIEF DESCRIPTION OF THE DRAWINGS

The following figures are exemplary embodiments wherein the like elements are numbered alike.

Features and aspects of embodiments are described below with reference to the accompanying drawings, in which elements are not necessarily depicted to scale.

Exemplary embodiments of the present disclosure are further described with reference to the appended figures. It is to be noted that the various features, steps, and combinations of features/steps described below and illustrated in the figures can be arranged and organized differently to result in embodiments which are still within the scope of the present disclosure. To assist those of ordinary skill in the art in making and using the disclosed assemblies, systems and methods, reference is made to the appended figures, wherein:

FIG. 1 is a side perspective view of an exemplary hybrid knitted fabric, according to the present disclosure.

FIG. 2 is a side perspective view of another exemplary hybrid knitted fabric, according to the present disclosure.

FIG. 3 is a cross-sectional side view of an exemplary composite material, according to the present disclosure.

FIG. 4 is a cross-sectional side view of another exemplary composite material, according to the present disclosure.

FIGS. 5A and 5B are cross-sectional side views of other exemplary composite materials, according to the present disclosure.

FIGS. 6A and 6B are cross-sectional side views of other exemplary composite materials, according to the present disclosure.

FIG. 7 is a cross-sectional side view of an exemplary automotive component, according to the present disclosure.

### DETAILED DESCRIPTION OF THE DISCLOSURE

The exemplary embodiments disclosed herein are illustrative of advantageous hybrid knitted fabrics and composite materials including hybrid knitted fabrics, and systems of the present disclosure and methods/techniques thereof. It should be understood, however, that the disclosed embodiments are merely exemplary of the present disclosure, which may be embodied in various forms. Therefore, details disclosed herein with reference to exemplary hybrid knitted fabrics and composite materials including hybrid knitted fabrics and associated processes/techniques of fabrication/assembly and use are not to be interpreted as limiting, but merely as the basis for teaching one skilled in the art how to make and use the advantageous hybrid knitted fabrics and composite materials including hybrid knitted fabrics and/or alternative composites/assemblies of the present disclosure.

The present disclosure provides improved hybrid knitted fabrics and composite materials including hybrid knitted fabrics, and improved systems/methods for utilizing and/or fabricating the hybrid knitted fabrics and composite materials.

More particularly, the present disclosure provides layered composite materials including hybrid knitted fabrics, the layered composite materials advantageously configured for non-score deployable passenger airbag (PAB) applications.

As noted, current practice provides that some conventional layered composite materials are used in some applications, and it can be necessary to score (weaken) the backside of areas of the layered composite material in order for the layered composite material to be installed and/or utilized, and such scoring can result in some problems. For example, some current artificial leathers are typically comprised of polymeric layer(s) and a backing layer (typically, a robust knitted textile). A current solution for “invisible” PABs within automotive interiors is for the artificial leather to be weakened (or “scored”) from the backside via some method (e.g., knife or laser). Typically, the weakening process requires weakening the entire thickness of the textile backing but also partially extends into the polymeric layer (closest to occupant). For traditional materials, this weakening process is necessary due to: (i) the knitted textile used has high mechanical resiliency (breaking load and tear propagation force); and (ii) the polymeric layer(s) are a majority of the total product thickness (e.g., polyvinyl chloride (PVC) and polyurethane (PUR)) and/or are mechanically resilient themselves (PUR and thermoplastic olefin (TPO)). Polymer chains are oriented during processing (e.g., extrusion) and this leads to directionality of mechanical properties (anisotropic tensile and tear). The presence of a score-line out-weighs this behavior and creates a preferred “path” for failure to occur.

It is noted that conventional skin scoring equipment can require significant capital investment and the process can be complex and generate high value scrap (e.g., near the end of the value stream). Additionally, due to the viscoelastic nature of the polymeric layer(s), over time, the backside scoring of the artificial leather can translate to the front side and become visible to the occupant (e.g., sagging). For example, after scoring, the polymer layer essentially becomes a bridge (material removed beneath it) and, over time, that bridge bends and becomes a slight “U” shape. This shape can be seen from the A-side.

In exemplary embodiments, the present disclosure provides layered composite materials including hybrid knitted fabrics, the layered composite materials advantageously configured for non-score deployable passenger airbag applications, thereby providing significant operational, manufacturing, commercial and/or revenue advantages as a result, and as discussed further below. For example, the improved composite materials of the present disclosure can be directly wrapped over passenger airbag (PAB) components without the need for pre-weakening methods (e.g., scoring). As such, the exemplary composites of the present disclosure can provide many advantages including, without limitation: (i) a simplified manufacturing sequence; (ii) can eliminate possible misalignment of a separate score line (e.g., knife scoring); (iii) can eliminate high-value scrap (e.g., composite scoring); (iv) provide consistent and reliable deployment performance; and/or (v) can eliminate the possibility of score line read-through for the customer (avoids transient performance of the scoreline, e.g., healing).

For example, scoring can be avoided by using a hybrid knitted fabric that comprises a first yarn having a single end break of 350 grams or lower and a linear density of 30 denier or higher; and a second yarn having a single end break of 450 grams or lower and a linear density of 20 denier or higher. The first yarn can be present in an amount that is greater than or equal to an amount of the second yarn. The first yarn can be distributed throughout the hybrid knitted fabric or concentrated in specific regions. In some embodiments, the regions of first yarn may consist of (contain only) the first yarn. The regions of first yarn (and the regions of the second yarn in some cases) may take the place of scoring. For example, when the hybrid knitted fabric is combined with a first layer (e.g., extruded material) to form a composite material, the regions of the first yarn (and the regions of the second yarn in some cases) are located where scoring would normally be used.

In exemplary embodiments, the present disclosure provides hybrid knitted fabrics with the following characteristics: (i) low breaking loads; (ii) low tear propagation forces; and/or (iii) the incorporation of polypropylene yarn for chemical bond during lamination.

In general, the present disclosure provides hybrid knitted fabrics having low mechanicals (e.g., specially developed low tenacity yarns) and enhanced bonding (e.g., incorporation of polypropylene yarn into knit structure (hybrid knit) for chemical bond to extruded layer(s)).

The advanced resin offering can provide: (i) CSW (cut, sew, wrap) specific characteristics (softness, flexibility, elasticity); (ii) low mechanicals (strength and tearing); and/or (iii) melt strength and strain hardening to support extrusion foaming. It is noted that a potential for product design is to include a foamed base layer (e.g., enabled by the melt strength and strain hardening to support extrusion foaming). The foaming process can be preferred because it creates: (i) cellular structure acting as failure initiation sites, and (ii) alleviates the polymer chain orientation during processing (during expansion, the foaming process orients the polymer chains more isotopically) and results in the more preferred property directionality (breaking loads and/or tear strength).

The present disclosure provides hybrid knitted fabrics with the following benefits: (i) eliminate skin scoring process from manufacturing (more efficient and simplified process; avoid scrap percent at end of value-stream; eliminate the need for capital and operation costs associated with skin scoring process; possibly eliminate all scoring processes if PAB initiation points can be integrated into the substrate mold design) (ii) improved deployment performance consistency; (iii) no score line visibility after ageing (e.g., heat, UV, humidity); and/or (iv) higher and more robust bond strength after lamination.

In exemplary embodiments of the present disclosure, it is noted that the hybrid knitted fabric (e.g., the support fabric) may be weft or warp knitted. In general, it is noted that woven fabrics typically have insufficient stretch, and nonwovens typically have insufficient stretch and high tear strength.

Referring now to the drawings, like parts are marked throughout the specification and drawings with the same reference numerals, respectively. Drawing figures are not necessarily to scale and in certain views, parts may have been exaggerated for purposes of clarity.

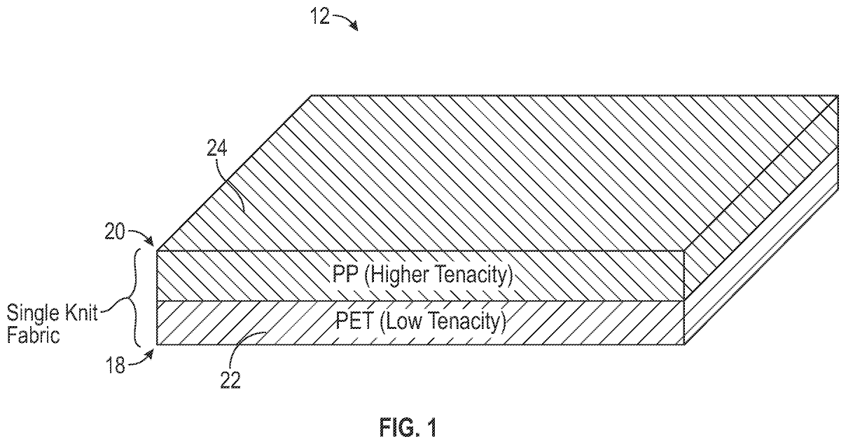

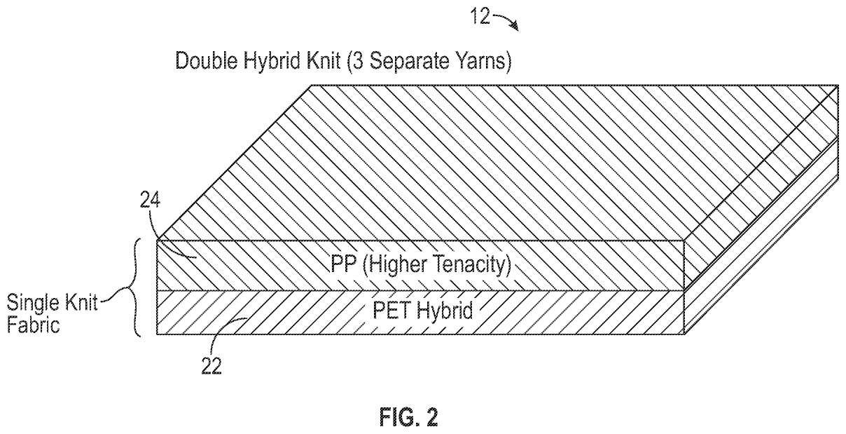

FIG. 1 is a side perspective view of an exemplary hybrid knitted fabric 12 (e.g., single knit fabric 12).

In exemplary embodiments, the hybrid knitted fabric 12 includes a first yarn having a single end break of 350 grams or lower and a linear density of 30 denier or higher; and a second yarn having a single end break of 450 grams or lower and a linear density of 20 denier or higher. The first yarn can be present in an amount that is greater than or equal to an amount of the second yarn. In certain embodiments, the first and second yarns are solid yarns, and the first yarn has a single end break of from 30 to 300 grams and a linear density of from 75 to 250 denier, and the second yarn has a single end break of from 30 to 300 grams and a linear density of from 40 to 200 denier. In some embodiments, the first and second yarns are solid yarns, and the first yarn has a single end break of from 200 to 250 grams and a linear density of from 150 to 210 denier, and the second yarn has a single end break of from 175 to 225 grams and a linear density of from 60 to 100 denier. In other embodiments, the first and second yarns have hollow cross-sections, and the first yarn has a single end break of from 50 to 200 grams, and a linear density of from 35 to 140 denier, and the second yarn has a single end break of from 40 to 175 grams, and a linear density of from 15 to 65 denier.

In certain embodiments, the first yarn has a tenacity that is less than or equal to 2.0 grams per denier, and the second yarn has a tenacity that is greater than or equal to 2.0 grams per denier. In other embodiments, the first yarn has a tenacity that is less than or equal to 1.50 grams per denier, and the second yarn has a tenacity that is greater than or equal to 2.5 grams per denier. In further embodiments, the first yarn has a tenacity that is 1.20 grams per denier, and the second yarn has a tenacity that is 2.5 grams per denier.

In general, the first yarn of hybrid knitted fabric 12 has a first single end break, and the second yarn has a second single end break. The first single end break can be greater than the second single end break, although the present disclosure is not limited thereto. In examples and without limitation, the first yarn can have a SEB equal to 231 g (178 denier) and a tenacity of 1.30 GPD; and the second yarn can have a SEB equal to 209 g (77 denier) and a tenacity of 2.72 GPD.

It is noted that single end break (“SEB”) is in [g] or [cN], and it equals tenacity times linear density.

In general, the hybrid knitted fabric 12 extends from a first end 18 to a second end 20. In some embodiments, a first region 22 proximal to the first end 18 comprises the first yarn, and a second region 24 proximal to the second end 20 comprises the second yarn, although the present disclosure is not limited thereto.

In example embodiments, the first yarn of hybrid knitted fabric 12 comprises polyester, and the second yarn comprises polypropylene, although the present disclosure is not limited thereto.

The yarns may comprise polyester yarns, polypropylene yarns or a combination of polyester yarns and polypropylene yarns. The yarns may also be bicomponent yarns (e.g., sheath-core yarns; islands-in-sea yarns; yarn blends; etc.). The yarns can comprise PVC, PUR and/or PE. The composition of the yarns may be chosen for greater compatibility and bond strength to the skin layer. For example, polypropylene yarns (e.g., second yarn) may be used to improve bond strength when used with a first layer 14 (e.g., thermoplastic polyolefin skin layer 14). In non-limiting examples, second yarn of region 24 can comprise PVC, and layer 14 can comprise PVC; or second yarn of region 24 can comprise PUR, and layer 14 can comprise PUR; or second yarn of region 24 can comprise PE (polyethylene), and layer 14 can comprise PE TPO.

In an exemplary composition and without limitation, the hybrid knitted fabric 12 comprises around 80% of the first yarn (e.g., PET), and around 20% of the second yarn (e.g., polypropylene).

In some embodiments, hybrid knitted fabric 12 comprises a third yarn (e.g., in first region 22), and it is noted that fabric 12 can comprise a plurality of additional yarns (e.g., in regions 22 and/or 24).

In an example embodiment, hybrid knitted fabric 12 comprises a third yarn (e.g., in first region 22). In some embodiments, the third yarn comprises polyester.

The yarns may be comprised of filaments having any cross sectional shape including circular, oval, flat oval, multi-lobular (e.g., trilobal), triangular, dogbone, lima bean, mushroom, y-shape, star-shaped, or irregular (e.g., the filament cross-sections that make up the yarn). The filaments, including hollow filaments, may be textured during the filament spinning process. For example, the filament surface may have scales, striations, or other features affecting failure initiation. These filaments may be used to form a continuous fiber yarn or a staple spun yarn. In example embodiments and without limitation, the continuous fiber yarns may have one to 1,000 filaments per yarn, or ten to 300 filaments per yarn, or 25 to 100 filaments per yarn. It is noted that the use of hollow filaments can have an effect on fabric weight/thickness.

In a non-limiting example, fabric 12 can have first yarn equal to 68 filaments (e.g., continuous filaments), and the second yarn equal to 50 filaments or 34 filaments. It is noted that certain applications of fabric 12 of the present disclosure can be limited to lower fabric thicknesses and, correspondingly, low yarn linear densities. Filament counts may be much higher for other exemplary applications (thicker fabrics), or if a spinning method allows for very fine filaments (e.g., nano filaments). It is noted that a staple fiber yarn can be utilized, and those can be specified differently by twist, end counts, and input staple fiber specifications (cut length, tenacity, denier).

Some yarn processing factors that can be utilized include draw ratio; texturing (physical or chemical); and twist.

The hybrid knitted fabric 12 may have a thickness of 0.25 to 1.50 millimeters (mm), or preferably, 0.50 to 1.25 mm. The hybrid knitted fabric 12 (e.g., double knit fabric 12) may have an area weight of 75 to 400 grams per square meter (g/m²), or 150 to 325 g/m². The hybrid knitted fabric 12 may be warp knitted or weft knitted.

Fabric 12 finishing processes (e.g., physical or chemical) can weaken the fabric 12 and/or improve bond strength, which correlates to improved performance. For example physical texturing can include needle texturing (commonly referred to as “suedeing”), and this does improve laminate bond strength. For example chemical processing of fabric 12, one can utilize certain solutions (e.g., for polyester fabrics, one can use 50 to 60% ethyl amine solutions).

The hybrid knitted fabric 12 may be combined with at least one additional layer (e.g., layer 14, 16) to form a layered composite 10. The additional layer 14, 16 may include thermoplastic olefin, foamed thermoplastic olefin, external foam (e.g., an external foam layer, such as a cross linked polypropylene foam), or combinations thereof. The thickness of the at least one additional layer 14, 16 may be 0.50 mm to 1.25 mm. The additional layer 14, 16 may have a show surface which may have texture or other decorative aspect.

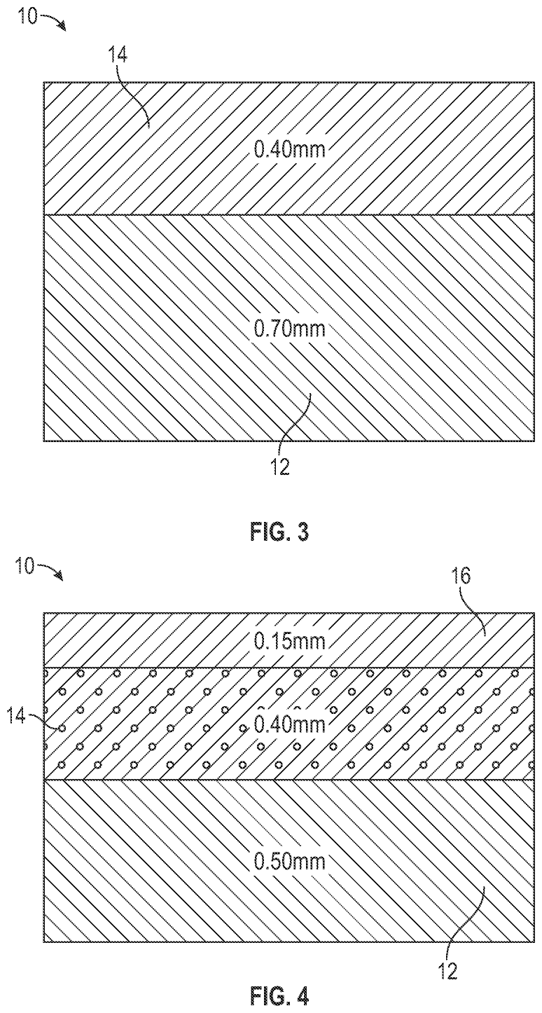

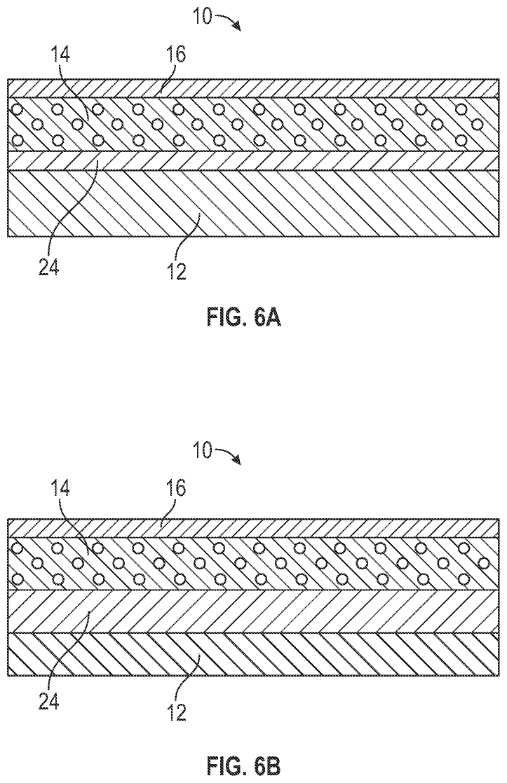

In certain embodiments, the layered composites 10 are fabricated where the thermoplastic olefin resin is chemically foamed during the extrusion process. Therefore, the cap layer (solid) 16 in FIGS. 4, 6A, 6B and 7, and base layer (foamed) 14 in FIGS. 4, 6A, 6B and 7 are simultaneously created in one extrusion process.

The thermoplastic olefin of layer 14, 16 may have a two phase morphology. The two phases may be co-continuous or a first phase may be dispersed in a second phase. The thermoplastic olefin may comprise polypropylene, polyethylene or a combination of polypropylene and polyethylene. In other embodiments, layer 14, 16 includes TPO-based elastomers (TPVs, SBCs, random copolymers, block-copolymers, α-olefin elastomers, etc.). The resin of layer 14, 16 can be tailored for low mechanicals (e.g., phase incompatibility, low molecular weight components, dissimilar viscosities). The thermoplastic olefin of layer 14, 16 may further include one or more inorganic fillers such as calcium carbonate, magnesium hydroxide (talc), wollastonite, mica, silica, dolomite, barium sulfate, alumina trihydroxide, magnesium hydroxide, magnetite, zinc oxide, titanium dioxide, and glass spheres. The thermoplastic olefin of layer 14, 16 may further include organic fillers, polymer spheres, high temperature incompatible polymers, and/or natural fibers.

The hybrid knitted fabric 12 may be laminated or otherwise adhered to the at least one additional layer 14, 16. It is also contemplated that the layered composite 10 may include multiple layers of hybrid knitted fabric 12 which can vary from each other in composition and/or yarn distribution, pattern, shape or a combination thereof.

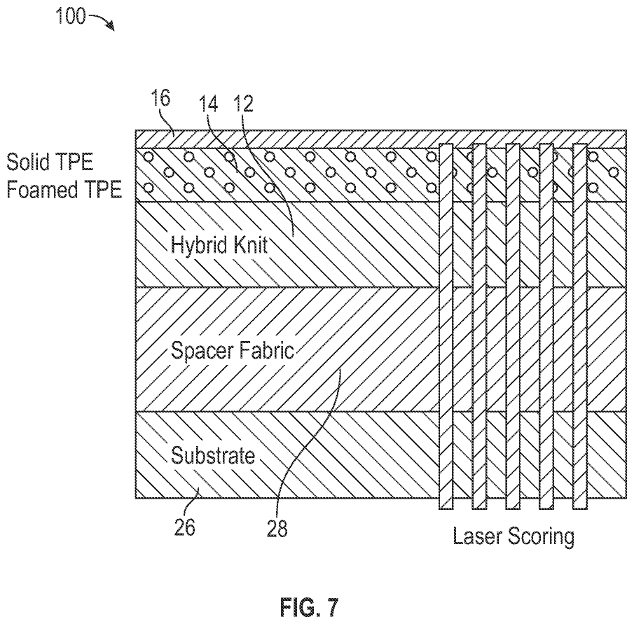

In some embodiments, the layered composite material 10 may be used as part of an interior automotive component. For example and as shown in FIG. 7, an interior automotive component 100 may comprise a substrate 26 having an inner surface and an outer surface and a layered composite material comprising 12, 14 and 16 disposed on a spacer fabric 28 (e.g., a 3.8 mm spacer fabric 28), which is disposed on the outer surface of substrate 26. It is noted that spacer fabric 28 may not be included in certain embodiments.

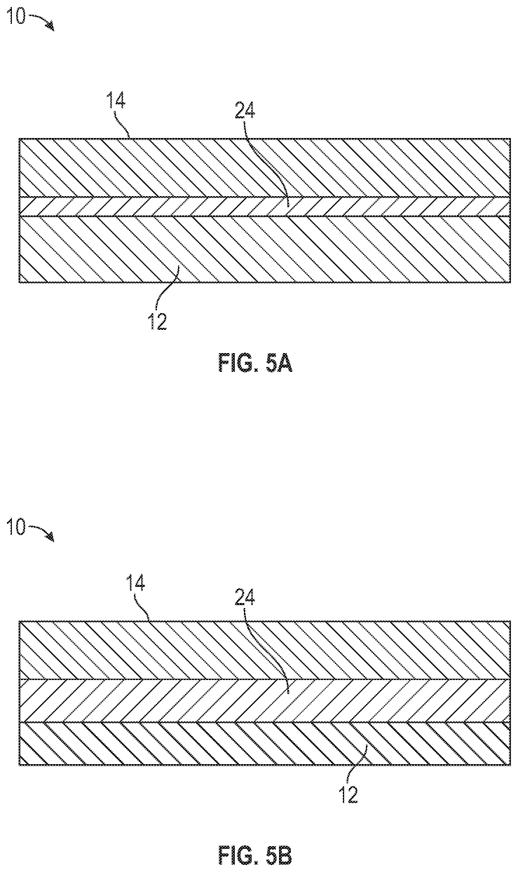

As such and as shown in FIGS. 3 to 6B, the present disclosure provides a composite material 10 comprising a hybrid knitted fabric 12 and a first layer 14 on the hybrid knitted fabric 12, where the hybrid knitted fabric 12 has a first yarn having a single end break of 350 grams or lower and a linear density of 30 denier or higher, and a second yarn having a single end break of 450 grams or lower and a linear density of 20 denier or higher. The first yarn can be present in an amount that is greater than or equal to an amount of the second yarn.

In general, the hybrid knitted fabric 12 and the first layer 14 are configured and dimensioned to be positioned relative to a vehicle airbag and to allow the vehicle airbag to break through the hybrid knitted fabric 12 and the first layer 14 without prescoring or pre-weakening the hybrid knitted fabric 12 and the first layer 14 (and through layer 16, when present).

In certain embodiments, the first layer 14 comprises a solid thermoplastic elastomer.

In some embodiments, the composite 10 includes a second layer 16 on the first layer 14, with the first layer 14 comprising a foam layer (e.g., a foamed thermoplastic elastomer 14), and the second layer 16 comprising a solid thermoplastic elastomer.

It is noted that the second yarn of fabric 12 can be chemically bonded to the first layer 14.

It is noted that the hybrid knitted fabric 12 can comprise a mechanical or chemical finished region (e.g., physical texturing (e.g., sueding) of the fabric 12 (e.g., to provide a sueded region); a chemical etched region by chemical etching of filament surface during finishing; etc.). Such processes will reduce mechanicals and improve performance of fabric 12.

The present disclosure also provides for an automotive component 100 comprising a substrate 26 having an inner surface and an outer surface; and a composite material 10 disposed relative to the outer surface of the substrate 26. The composite material 10 can comprise a hybrid knitted fabric 12 and a first layer 14 on the hybrid knitted fabric 12; and with the hybrid knitted fabric 12 having a first yarn having a single end break of 350 grams or lower and a linear density of 30 denier or higher, and a second yarn having a single end break of 450 grams or lower and a linear density of 20 denier or higher. The first yarn can be present in an amount that is greater than or equal to an amount of the second yarn.

The automotive component 100 can provide that the substrate 26 is positioned relative to a vehicle airbag; and provide a spacer fabric layer 28 positioned on the outer surface of the substrate 26.

The automotive component 100 can have the hybrid knitted fabric 12 and the first layer 14 configured and dimensioned to be positioned relative to a vehicle airbag and to allow the vehicle airbag to break through the hybrid knitted fabric 12 and the first layer 14 without pre-scoring or pre-weakening the hybrid knitted fabric 12 and the first layer 14 (and through layer 16, when present).

As used herein, the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. In addition, it is noted that the terms “bottom” and “top” are used herein, unless otherwise noted, merely for convenience of description, and are not limited to any one position or spatial orientation. The numerical ranges described herein are non-limiting ranges. Values outside of the described non-limiting ranges are considered to be within the scope of various embodiments.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

The ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity and are to be construed to cover both the singular and the plural, unless otherwise indicated herein or clearly contradicted by context. “Or” means “and/or” unless clearly stated otherwise. Reference throughout the specification to “some embodiments”, “an embodiment”, and so forth, means that a particular element described in connection with the embodiment is included in at least one embodiment described herein, and may or may not be present in other embodiments. In addition, it is to be understood that the described elements may be combined in any suitable manner in the various embodiments. A “combination thereof” is open and includes any combination comprising at least one of the listed components or properties optionally together with a like or equivalent component or property not listed.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Although the systems and methods of the present disclosure have been described with reference to exemplary embodiments thereof, the present disclosure is not limited to such exemplary embodiments and/or implementations. Rather, the systems and methods of the present disclosure are susceptible to many implementations and applications, as will be readily apparent to persons skilled in the art from the disclosure hereof. The present disclosure expressly encompasses such modifications, enhancements and/or variations of the disclosed embodiments. Since many changes could be made in the above construction and many widely different embodiments of this disclosure could be made without departing from the scope thereof, it is intended that all matter contained in the drawings and specification shall be interpreted as illustrative and not in a limiting sense. Additional modifications, changes, and substitutions are intended in the foregoing disclosure. Accordingly, it is appropriate that the appended claims be construed broadly and in a manner consistent with the scope of the disclosure.

What is claimed is:

1. A hybrid knitted fabric comprising:
a first yarn having a single end break of 350 grams or lower and a linear density of 30 denier or higher;
a second yarn having a single end break of 450 grams or lower and a linear density of 20 denier or higher; and
wherein the first yarn is present in an amount that is greater than or equal to an amount of the second yarn.

2. The hybrid knitted fabric of claim 1, wherein the first and second yarns are solid yarns;
wherein the first yarn has a single end break of from 30 to 300 grams, and a linear density of from 75 to 250 denier; and
wherein the second yarn has a single end break of from 30 to 300 grams, and a linear density of from 40 to 200 denier.

3. The hybrid knitted fabric of claim 1, wherein the first and second yarns are solid yarns;
wherein the first yarn has a single end break of from 200 to 250 grams, and a linear density of from 150 to 210 denier; and
wherein the second yarn has a single end break of from 175 to 225 grams, and a linear density of from 60 to 100 denier.

4. The hybrid knitted fabric of claim 1, wherein the first and second yarns have hollow cross-sections;
wherein the first yarn has a single end break of from 50 to 200 grams, and a linear density of from 35 to 140 denier; and
wherein the second yarn has a single end break of from 40 to 175 grams, and a linear density of from 15 to 65 denier.

5. The hybrid knitted fabric of claim 1, wherein the first yarn comprises polyester; and
wherein the second yarn comprises polypropylene.

6. The hybrid knitted fabric of claim 1, wherein the first yarn is present in an amount that is greater than an amount of the second yarn.

7. The hybrid knitted fabric of claim 1 further comprising a third yarn; and
wherein the third yarn comprises polyester.

8. The hybrid knitted fabric of claim 1, wherein the hybrid knitted fabric extends from a first end to a second end;
wherein a first region proximal to the first end comprises the first yarn; and
wherein a second region proximal to the second end comprises the second yarn.

9. The hybrid knitted fabric of claim 1, wherein the single end break of the first yarn is greater than the single end break of the second yarn.

10. A composite material comprising:
a hybrid knitted fabric and a first layer on the hybrid knitted fabric;
wherein the hybrid knitted fabric has a first yarn having a single end break of 350 grams or lower and a linear density of 30 denier or higher, and a second yarn having a single end break of 450 grams or lower and a linear density of 20 denier or higher; and
wherein the first yarn is present in an amount that is greater than or equal to an amount of the second yarn.

11. The composite material of claim 10, wherein the hybrid knitted fabric and the first layer are configured and dimensioned to be positioned relative to a vehicle airbag and to allow the vehicle airbag to break through the hybrid knitted fabric and the first layer without pre-scoring or pre-weakening the hybrid knitted fabric and the first layer.

12. The composite material of claim 10, wherein the first layer comprises a solid thermoplastic elastomer.

13. The composite material of claim 10 further comprising a second layer on the first layer;
wherein the first layer comprises a foam layer, and the second layer comprises a solid thermoplastic elastomer.

14. The composite material of claim 13, wherein the first layer comprises a foamed thermoplastic elastomer.

15. The composite material of claim 10, wherein the second yarn is chemically bonded to the first layer.

16. The composite material of claim 10, wherein the hybrid knitted fabric comprises a mechanical or chemical finished region.

17. An automotive component comprising:
a substrate having an inner surface and an outer surface; and
a composite material disposed relative to the outer surface of the substrate;
wherein the composite material comprises a hybrid knitted fabric and a first layer on the hybrid knitted fabric; and
wherein the hybrid knitted fabric has a first yarn having a single end break of 350 grams or lower and a linear density of 30 denier or higher, and a second yarn having a single end break of 450 grams or lower and a linear density of 20 denier or higher; and
wherein the first yarn is present in an amount that is greater than or equal to an amount of the second yarn.

18. The automotive component of claim 17, wherein the substrate is positioned relative to a vehicle airbag; and
wherein a spacer fabric layer is positioned on the outer surface of the substrate.

19. The automotive component of claim 17, wherein the hybrid knitted fabric and the first layer are configured and dimensioned to be positioned relative to a vehicle airbag and to allow the vehicle airbag to break through the hybrid knitted fabric and the first layer without pre-scoring or pre-weakening the hybrid knitted fabric and the first layer.

20. The automotive component of claim 17, wherein the first yarn comprises polyester; and
wherein the second yarn comprises polypropylene.
